(19) United States
(12) Patent Application Publication
(10) Pub. No.: US 2025/0332530 A1
(43) Pub. Date: Oct. 30, 2025

(54) CONNECTING PIECE, FILTER ELEMENT ASSEMBLY AND FILTER

(71) Applicant: ZHEJIANG LAIEN FILTRATION SYSTEM CO., LTD., Huzhou City (CN)

(72) Inventors: QING-LIN DENG, Huzhou City (CN); JIAN-BIN CHENG, Huzhou City (CN); YU ZHANG, Huzhou City (CN); XIAO-WEI YING, Huzhou City (CN)

(21) Appl. No.: 19/194,024

(22) Filed: Apr. 30, 2025

(30) Foreign Application Priority Data
Apr. 30, 2024 (CN) 202410536955.2
Apr. 30, 2024 (CN) 202420931768.X

(51) Int. Cl. B01D 35/30; B01D 27/08

(52) U.S. Cl. CPC B01D 35/306; B01D 27/08; B01D 2201/301

(57) ABSTRACT

The invention discloses a connecting piece, a filter element assembly and a filter, wherein the connecting piece comprises hollow-out bracket and end disc connected with one end of the bracket, the bracket is arranged on the periphery of the filter element in a surrounding manner and is used for radially limiting the filter element, and the outer end face of the end disc is eccentrically provided with oil return plug; Wherein the bracket is provided with connecting part for connecting the filter element, so that the connecting part is moved out together with the filter element in the process of moving out the filter element, the oil return plug is removed, and the oil return channel is opened. According to the scheme, the position of the oil return plug can be adjusted in a rotating mode, and the filter element assembly can be installed without much operation experience.

### TECHNICAL FIELD

The invention belongs to the technical field of filters, and particularly relates to a connecting piece, a filter element assembly and a filter.

### BACKGROUND

In the maintenance and replacement process of the filter element assembly of the filter, in order to avoid environmental pollution caused by oil overflow, an oil return channel is arranged in the filter assembly, the filter element assembly is provided with an oil return plug and a guide piece (positioning piece), when the filter element assembly is correctly installed, the guide piece (positioning piece) enables the oil return plug of the filter element assembly to seal the oil return channel to ensure normal system oil pressure, In the process of removing the filter element assembly, it is necessary to open the oil return channel to discharge the oil in the filter assembly.

Typically, during installation of the filter, the operator must accurately adjust the rotational position between the guide piece and the oil return plug when installing the annular filter element assembly into the filter housing, which is prone to errors based on experience. In addition, in practical application, because the filter element assembly is different from the matched filter assembly in structure, it is necessary to strictly control the positions of these parts during rotation to complete the assembly of the filter element assembly and ensure that the position of the filter element assembly does not deviate. Therefore, the machining process of the filter element assembly becomes complex and difficult to control, the machining position deviation is easy to occur, the product is scrapped, and the cost of the product is high.

### SUMMARY

The invention mainly aims to provide a connecting piece, a filter element assembly and a filter, and aims to solve the technical problems that a filter element with a guide piece is difficult to operate and complex to process in the using process.

In order to achieve the above object, the present invention proposes a connecting piece comprising:
The hollowed-out bracket is arranged on the periphery of the filter element in a surrounding manner and is used for radially limiting the filter element;
An end disc connected with one end of the hollowed-out bracket, wherein an oil return plug is eccentrically arranged on the outer end surface of the end disc and is used for sealing an oil return channel in the filter assembly;
Wherein the hollowed-out bracket is provided with a connecting part for connecting the filter element, so that the connecting part is moved out together with the filter element in the process of moving out the filter element, the oil return plug is removed, and the oil return channel is opened.

Optionally, the end disc is hollow-out.

Optionally, the end disc has an outwardly extending locating profile for mating with an internal component of the filter assembly, so that when the connecting piece is mounted in the filter assembly, the oil return plug enters and closes the oil return channel.

Optionally, the locating profile is a wall extending axially outwards from the end face of the end disc.

Optionally, the wall includes at least one bend to position the connecting piece within the filter assembly.

Alternatively, the hollowed-out bracket and the end disc are integrally injection-moulded.

Optionally, the connecting part is provided in a plurality of elastic structure.

Optionally, the elastic structure is a cantilever structure for detachably connecting the filter element.

The invention also provides a filter element assembly which comprises a filter element and the connecting piece.

The filter element comprises:
An annular filter medium having a central cavity set around its central axis;
A first end cap and a second end cap connected to both ends of the annular filter medium;
The hollowed-out bracket is arranged around the periphery of the annular filter medium and is connected with one of the first end cap and the second end cap.

Optionally, the first end cap is arranged close to the end disc, and the first end cap and the end disc are respectively provided with a first opening and a second opening into the central cavity.

The present invention also provides a filter comprising:
The filter element assembly;
A filter assembly, the filter assembly being provided with an oil return channel, the filter assembly being provided with a central tube communicating with the central cavity;
A screw cap and connect it with the open end thread of the filter assembly to seal it.

Optionally, the filter assembly is provided with a mating profile that mates with the locating profile.

Optionally, the mating profile is formed in the central tube.

In the technical scheme of the invention, when the filter element is assembled, an operator can firstly install the connecting piece with the oil return plug inside the filter assembly, meanwhile, the oil return plug on the end disc also enters and closes the oil return channel in the assembly, and then the filter element is arranged in the screw cap or directly put in the connecting piece, and the connecting piece and the filter element are relatively fixed through the connecting part, Finally, tighten the screw cap onto the assembly. When disassembling the filter element, unscrew the screw cap to take out the filter element and the connector at the same time. According to the scheme, it is possible to avoid using rotation to adjust the position of the oil return plug, the filter element assembly can be installed without much operation experience, the product is simple to process, and the deviation requirement is low.

### BRIEF DESCRIPTION OF THE DRAWINGS

In order to more clearly illustrate the embodiments of the present invention or the technical solutions in the prior art, the following will briefly introduce the drawings used in the description of the embodiments or the prior art. Obviously, the drawings in the following description are only some embodiments of the present invention. For those of ordinary skill in the art, other figures may also be derived from the structures shown in these figures without requiring creative labor.

FIG. 1 is a perspective structural diagram of a connecting piece according to an embodiment of the present invention;

FIG. 2 is a bottom view of FIG. 1;

FIG. 3 is a perspective structural diagram of an embodiment of the filter element assembly provided by the present invention;

FIG. 4 is an exploded view of an embodiment of the filter provided by the present invention;

FIG. 5 is a top view of the filter assembly of FIG. 4;

FIG. 6 is a cross-sectional view of an axial section of an embodiment of the filter provided by the present invention;

FIG. 7 is a perspective structural diagram of another embodiment of the connecting piece provided by the present invention;

FIG. 8 is a bottom view of FIG. 7;

FIG. 9 is a perspective view of another embodiment of the filter element assembly provided by the present invention;

FIG. 10 is an exploded view of another embodiment of the filter provided by the present invention;

FIG. 11 is a top view of the filter assembly of FIG. 10;

FIG. 12 is a perspective view of the center tube of FIG. 11;

FIG. 13 is a perspective view of a portion of the structure of FIG. 10;

FIG. 14 is a cross-sectional view of an axial section of another embodiment of the filter provided by the present invention.

Label Description: connecting piece 100, a hollowed-out bracket 1, a connecting part 1a, a first identification part 1b, an end disc 2, a second opening 2a, an oil return plug 21, a locating profile 22, a bend 22a, a filter element 200, an annular filter medium 201, a central cavity 201a, first end cap 202, a first opening 202a, The second end cap 203, the clamping part 203a, the filter assembly 300, oil return channel 300a, the oil inlet channel 300b, the oil outlet channel 300c, the central tube 301, the mating profile 301a, the second identification part 302, the screw cap 400, the matching part 400a, and the filter 1000.

The realization of the object, the functional features and the advantages of the present invention will be further described in connection with the embodiments with reference to the accompanying drawings.

### DETAILED DESCRIPTION

The technical solutions in the embodiments of the present application will be clearly and completely described below with reference to the drawings in the embodiments of the present application. Obviously, the described embodiments are only a part of the embodiments of the present application, not all of the embodiments. Based on the embodiments in the present application, all other embodiments obtained by those of ordinary skill in the art without creative work are within the scope of the present application.

To better describe and illustrate embodiments of the present application, reference is made to one or more of the accompanying drawings, but additional details or examples used to describe the drawings should not be construed to limit the scope of any of the inventions, presently described embodiments, or preferred modes of the present application.

In the description of the present invention, it should be noted that the orientation or positional relationship indicated by the terms “length”, “width”, “upper”, “lower”, “front”, “rear”, “left”, “right”, “top”, “bottom”, “inner”, “outer”, etc. Are based on the positional relationship shown in the drawings, and are only for the convenience of describing the present invention. And does not indicate that the device referred to must have or operate in a particular orientation and is therefore not to be construed as limiting the invention.

Unless defined otherwise, all technical and scientific terms used herein have the same meaning as commonly understood by one of ordinary skill in the art to which this application belongs. The terminology used herein in the description of the present application is for the purpose of describing particular embodiments only and is not intended to be limiting of the application.

In practical application, because the filter element assembly is different from the matched filter assembly in structure, it is necessary to strictly control the position of these parts during rotation to complete the assembly of the filter element assembly and ensure that its position does not deviate. Therefore, the machining process of the filter element assembly becomes complex and difficult to control, the machining position deviation is easy to occur, the product is scrapped, and the cost of the product is high.

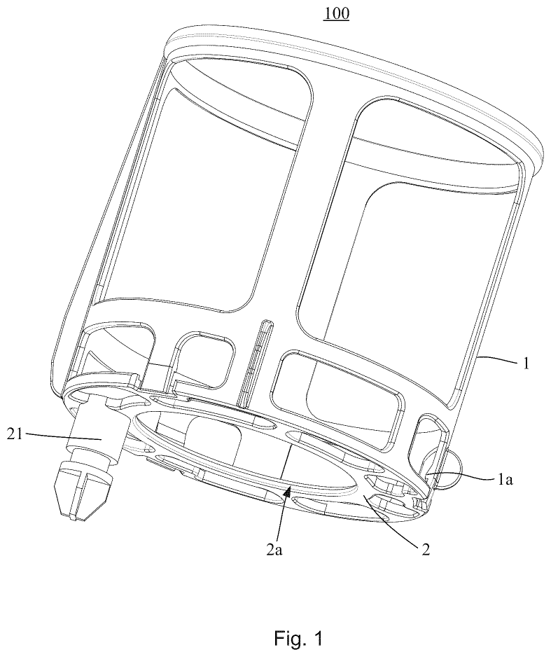

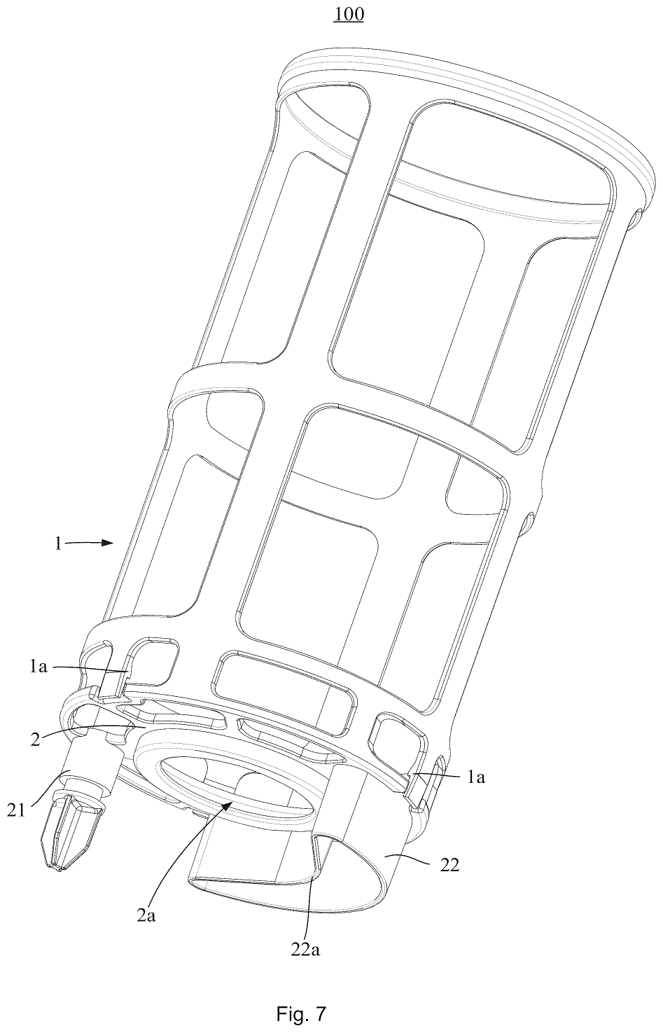

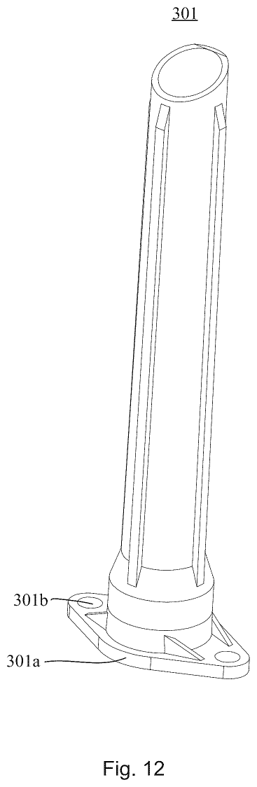

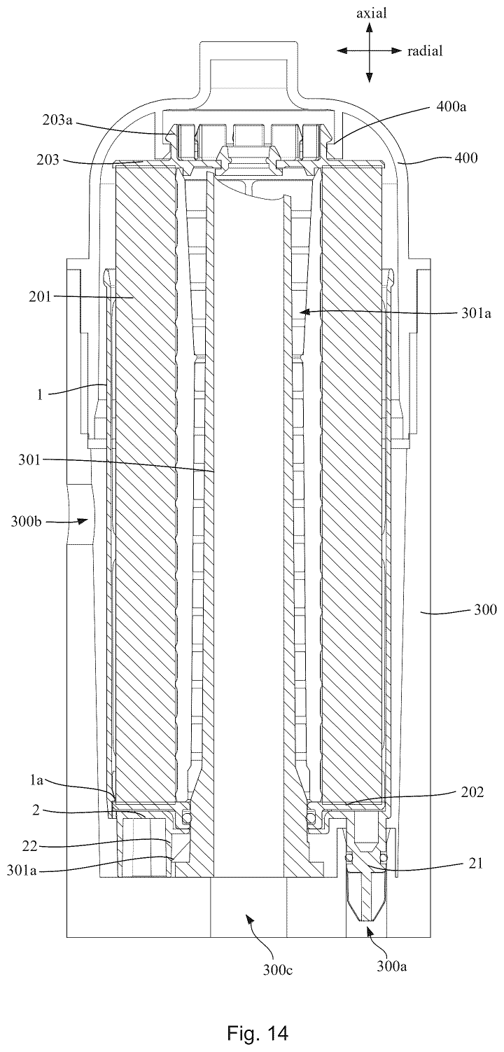

In view of this, the present invention provides a connecting piece, which is mainly used to be installed in a fuel filter or an oil filter to connect a filter element and a filter assembly respectively, and a user can operate the connecting piece without much experience. Referring to FIGS. 1-14, especially FIGS. 1 and 7, the connecting piece 100 includes a hollowed-out bracket 1 and an end disc 2 connected to one end of the hollowed-out bracket 1.

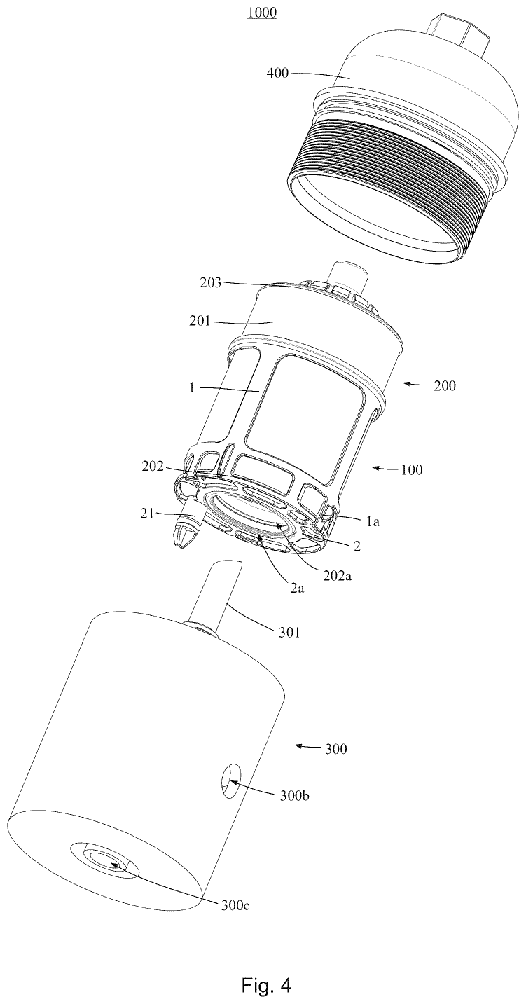

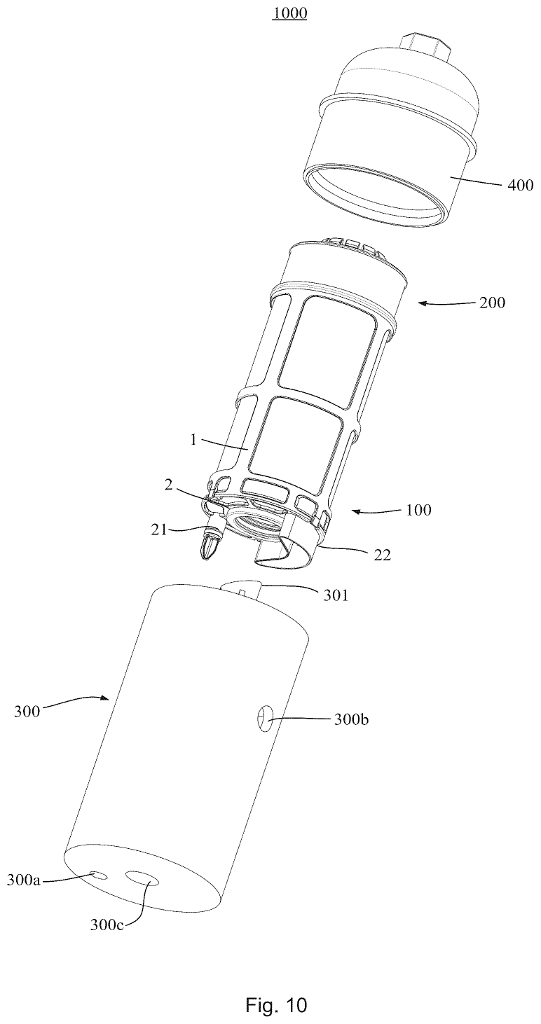

Specifically, referring to FIG. 4 and FIG. 10, the hollowed-out bracket 1 is an annular structure extending along the axial direction thereof, and the annular structure is hollow to form a plurality of holes for oil to pass through. The filter element 200 is detachably mounted on the inner side of the annular hollowed-out bracket 1, or is sleeved on the outer side of the hollowed-out bracket 1, so as to restrict the movement of the filter element 200 in the radial direction after the installation is completed. At its axially extending end, the annular hollowed-out bracket 1 is connected to an end disc 2, on the outer face of which an oil return plug 21 is eccentrically provided. It should be noted that the shape of the hollowed-out bracket 1 can also be designed to be various, for example, the hollowed-out bracket 1 is formed by connecting a plurality of support rods extending along the axial direction and a circular ring member, or a hole is directly dug on a cylindrical member, or the bracket 1 is formed by injection molding. Further, in the present embodiment, the oil return plug 21 extends in the axial direction and includes a pin and a seal ring (not shown in the drawings) sleeved on the pin.

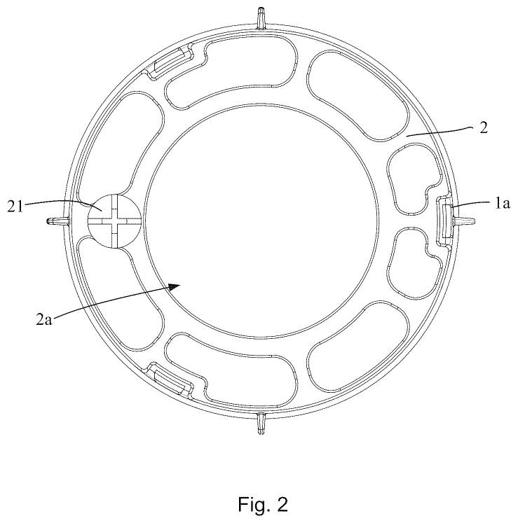

In order to enable the hollowed-out bracket 1 to axially limit the filter element 200, the hollowed-out bracket 1 is provided with a connecting part 1a. Referring to FIG. 1 and FIG. 2, in an embodiment of the present invention, the connecting part 1a is a plurality of elastic buckles arranged on the hollowed-out bracket 1, and each buckle extends along the axial direction. Through the extrusion of the filter element 200, the buckle is elastically deformed outward, and is finally clamped with the outer edge of the end cover of the filter element 200, so that the hollowed-out bracket 1 is connected with the filter element 200 and the axial movement of the filter element 200 is limited, but the filter element 200 and the end cover thereof can still easily rotate relative to the hollowed-out bracket 1. Therefore, in the process of moving the filter cartridge 200 out of the filter assembly 300, the connecting member 100 can be moved out together with the filter cartridge 200, so that the oil return plug 21 is removed and the oil return passage 300a is opened, and the oil in the assembly is returned to the oil tank. Of course, the embodiment of the present invention is not limited to this. The connecting part 1a may also be a bump or other structure that can restrict the axial movement of the filter element 200, and is not limited to the form of a buckle. The connecting method of the connecting part 1a and the filter element 200 may also be interference fit, elastic connection, etc., which will not be described in detail here.

In a preferred embodiment, there are four connecting part 1a, that is, four buckles are uniformly distributed along the circumferential direction. A preferable structure of the buckle is a cantilever structure extending outwards along the axial direction, one end of the cantilever structure is connected with the hollowed-out bracket 1, and the other end is arranged in the air. When the cantilever structure is pressed by the filter element 200 (especially the end cover of the filter element), the cantilever structure can elastically deform outward along the approximate radial direction; the cantilever structure is provided with a clamping block, so that the filter element 200 can be limited between the clamping block and the end disc 2 in the deformation process. It should be understood that in other embodiments of the present invention, the number of the connecting part 1a may be other, preferably three or more.

It should be noted that the hollowed-out bracket 1 and the connecting part 1a thereof are only used for limiting the movement of the filter element 200 in the axial direction and the radial direction, so as to prevent the oil return plug 21 from being damaged. Although the connecting part 1a is clamped with the end cover of the filter element 200, the filter element 200 can still rotate relative to the hollowed-out bracket 1, so that the filter element 200 can be rotated and pulled out together with the screw cap 400 when the filter element 200 is disassembled.

Of course, even if the connecting part 1a and the filter element 200 are stuck and cannot rotate relative to each other, the purpose of preventing the oil return plug 21 from being damaged can also be achieved by connecting the screw cap 400 and the filter element 200 in a rotatable manner.

Referring to FIG. 4 and FIG. 10, when assembling the filter element, the operator can first install the connecting piece 100 with the oil return plug 21 inside the filter assembly 300, and at the same time, the oil return plug 21 on the end disc 2 also enters and closes the oil return channel 300a in the assembly, and then install the filter element 200 into the screw cap 400. Or the filter element 200 is directly put into the connecting piece 100, and the filter element 200 and the connecting piece 100 are relatively fixed through the connecting part 1a, and finally the screw cap 400 is screwed on the filter assembly 300. When the filter element 200 is disassembled, because the filter element 200 and the screw cap 400 are in a clamping fit relationship, after the screw cap 400 is unscrewed, the screw cap 400 takes out the filter element 200, and at the same time, the filter element 200 can also take out the connecting piece 100. According to the scheme, the position of the oil return plug can be prevented from being adjusted in a rotating mode, the filter element can be installed without much operation experience, the problem that the installation cost is high due to the fact that the oil return plug is installed on the filter element is solved, the product is simple to process, and the deviation requirement is low.

In order to facilitate the alignment of the oil return plug 21 on the end disc 2 with the oil return channel 300a in the filter assembly 300, in the preferred embodiment, the end disc 2 further has an outwardly extending locating profile 22 as an auxiliary locating structure, and the locating profile 22 can be matched with the inner member (having the mating profile 301a) of the filter assembly 300.

When assembling the filter element 200, the operator can visually align the locating profile 22 of the connecting piece 100 with the internal component of the filter assembly 300 having the mating profile 301a, and then guide the connecting piece 100 into the filter assembly 300 by means of the locating profile 22. At the same time, the oil return plug 21 on the end disc 2 also enters and closes the oil return channel 300a in the filter assembly 300, and then the filter element 200 is installed. Wherein the direction of extension of the pin should correspond to the locating profile 22, preferably in the axial direction.

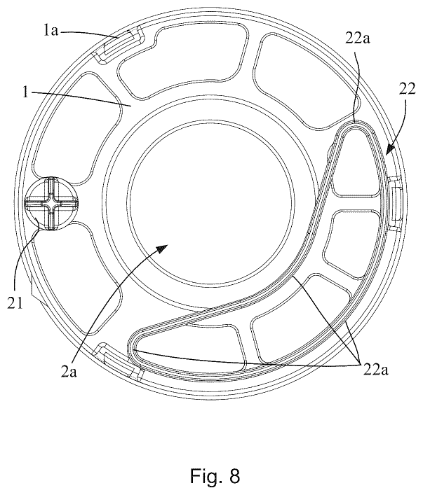

Referring to FIGS. 7 and 8, in another embodiment of the present invention, the locating profile 22 is a wall extending axially outward from the end face of the end disc 2, and the wall is a thin plate structure continuously encircling the first end disc 2 in the circumferential direction. To match the internal components of the filter assembly 300, the cross-section resembles the shape of a meniscus. Correspondingly, the mating profile 301a in the filter assembly 300 is a projection, the structural mating being achieved by a sliding fit between the wall and the surface of the projection. Of course, the locating profile 22 and the mating profile 301a can also be matched visually, and the positioning fit can be achieved without contact. It should be noted that the locating profile 22 and the mating profile 301a are not clamped with each other, and only play a role of sliding and guiding during the axial installation of the connecting piece 100. In addition, in other embodiments, the locating profile 22 may also be an irregular shape formed by a solid structure such as a bump or a boss, and the locating profile 22 may also be formed by surrounding the first end disc 2 discontinuously in the circumferential direction, which will not be described in detail here.

Further, referring to FIGS. 7 and 8, in the preferred embodiment of the present invention, the wall forming the locating profile 22 includes four bend 22a, each of which is connected to enclose the wall, and the cross section of the wall is in a meniscus shape. During the installation of connecting piece 100 onto filter assembly 300, by means of the bent 22a of the wall, the operator can visually align the mating profile 301a on the filter assembly 300, thereby achieving a positional fit, preventing relative rotation between the wall and the mating profile 301a, and reducing the stress on the oil return plug 21 during use. Of course, the embodiment of the present invention is not limited thereto, and the number of the bend 22a of the wall may be other, for example, a triangular prism-shaped wall surrounded by three bend 22a. Of course, the end face of the wall may also be designed to be circular, elliptical, or the like, as long as there is no relative rotation between the wall and the mating profile 301a.

It should be appreciated that the bent 22a can better match the locating profile 22 and the mating profile 301a. In other embodiments, the bend 22a may not be provided, and the positioning fit may also be achieved by planar guidance.

Please refer to FIG. 1, FIG. 2 and FIG. 4, each connecting part 1a is arranged close to the end disc 2 so as to be clamped with the end cover of the filter element, but this also reduces the gap between the end disc 2 and the end cover of the filter element 200, so that after the filter element 200 is installed, the end cover of the filter element 200 and the end disc 2 of the connecting piece 100 are clung to each other, in order to prevent the clinging of the end disk 2 and the connecting piece 100 from generating an adsorption force (such as surface tension), In an embodiment of the present invention, the end disc 2 is hollow, so that the oil in the gap between the end cover of the filter element 200 and the end disc 2 can leak out, and the adsorption force between the end cover of the filter element 200 and the end disc 2 of the connecting piece 100 can be reduced, so that the filter element 200 can be easily separated from the connecting piece 100.

In order to improve the strength of the connecting piece 100, in one embodiment of the present invention, the bracket 1 and the end disc 2 are integrally injection molded. The end of the annular bracket 1 is connected to the outer periphery of the end disc 2, and the oil return plug 21 is formed on the other end surface of the end disc 2 opposite to the hollowed-out bracket 1. Of course, the connecting piece 100 can also be made of other materials, such as metal.

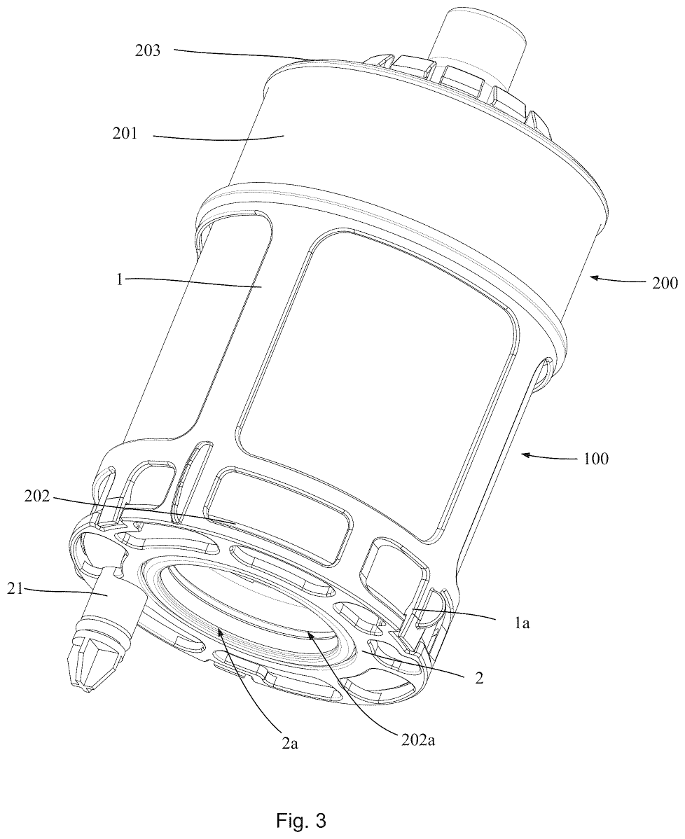

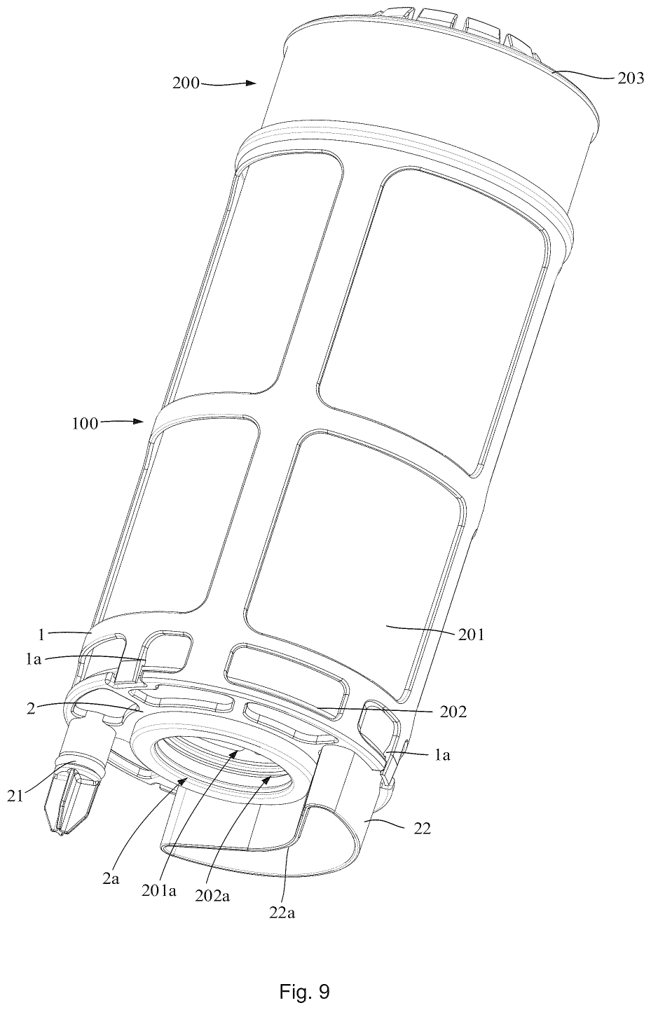

The present invention also provides a filter element assembly. FIG. 3 and FIG. 9 respectively show two embodiments of the filter element assembly provided by the present invention. Referring to FIGS. 3 and 9, the cartridge assembly includes a filter element 200 and the connecting piece 100 described above.

Specifically, the filter element 200 comprises an annular filter medium 201, and a first end cap 202 and a second end cap 203 connected to both ends of the annular filter medium 201. The annular filter medium 201 has a central cavity 201a defined around a central axis thereof, which constitutes a clean side and a non-clean side of the filter element 200, respectively, together with an outer side of the annular filter medium 201. The hollowed-out bracket 1 of the connecting piece 100 surrounds the outer circumference of the annular filter medium 201 to limit the movement of the filter element 200 in the radial direction. In this embodiment, the connecting part 1a of the hollowed-out bracket 1 is connected to the first end cap 202 of the filter element 200. Of course, in other embodiments, the connecting part 1a of the hollowed-out bracket 1 may also be connected to the second end cap 203 of the filter element 200. Alternatively, the connecting part 1a of the hollowed-out bracket 1 may be connected to the outer member of the annular filter medium 201.

In order to enable the oil to be pumped into or out of the central cavity 201a, in an embodiment of the present invention, the first end cap 202 and the end disc 2 abut against each other, and the first end cap 202 and the end disc 2 respectively define a first opening 202a and a second opening 2a into the central cavity 201a. The first opening 202a and/or the second opening 2a are used for sealing connection with the central tube 301 in the filter assembly 300, so that the oil containing particles is pumped in or the clean oil is pumped out.

As a preferred embodiment, the inner wall of the first opening 202a is provided with a sealing ring. When the filter element 200 is installed, the contact between the outer periphery of the central tube 301 in the filter assembly 300 and the sealing ring in the first opening 202a gradually becomes tight, so that the first opening 202a of the central cavity 201a is sealed. The invention also provides a filter which is mainly used for filtering engine oil or fuel oil, and FIGS. 4-6 and FIGS. 10-14 respectively show two embodiments of the filter provided by the invention. Referring to FIGS. 4-6, the filter 1000 includes the filter element assembly and the filter assembly 300 (i.e., the filter housing). The filter assembly 300 has an oil return channel 300a communicating with the oil tank and an oil inlet channel 300b communicating with the oil tank.

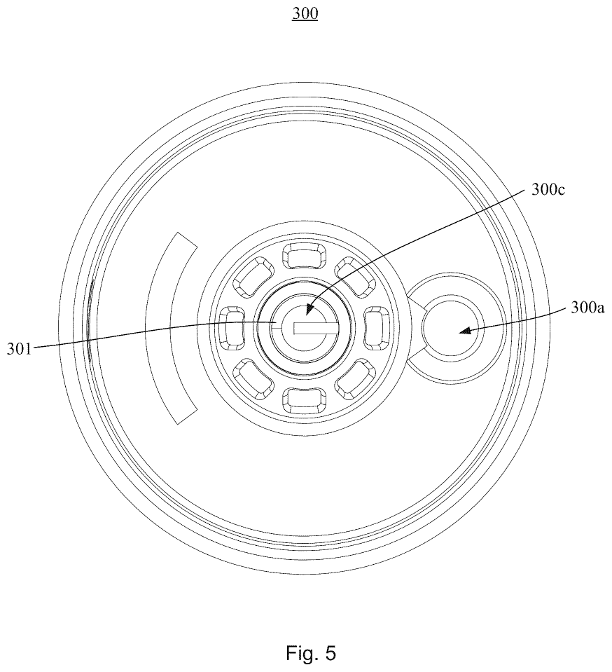

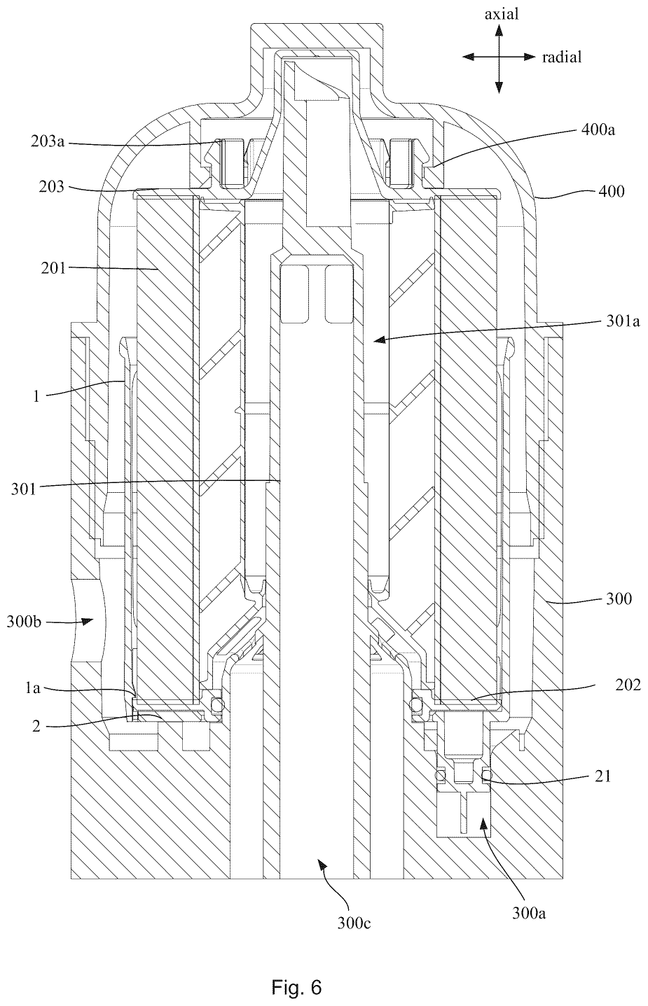

Referring to FIGS. 5 and 6, in one embodiment of the present invention, the filter assembly 300 includes a central tube 301 having one end connected to the central cavity 201a. In addition, the bottom of the filter assembly 300 is further provided with a clean oil channel 300c, and the other end of the central tube 301 is communicated with the clean oil channel 300c to pump the filtered oil. Fuel or engine oil enters the inside of the filter assembly 300 from the oil inlet channel 300b and is filtered by the annular filter medium 201, and the filtered clean oil enters the central cavity 201a and is finally pumped out from the central tube 301 to the clean oil channel 300c under the pumping action to enter the engine. Of course, the filter further includes a screw cap 400 for closing the filter assembly 300, and the filter assembly 300 and the screw cap 400 are detachably connected by a screw thread.

The filter assembly 300 is provided with a mating profile 301a matched with the locating profile 22, an oil return channel 300a connected to the oil tank, and an oil inlet channel 300b for the oil containing particulate matter.

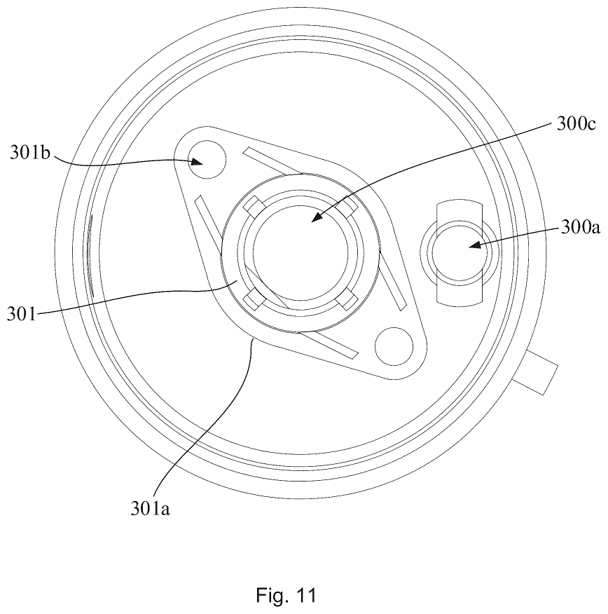

Referring to FIGS. 11, 12 and 14, in another embodiment of the present invention, the filter assembly 300 has a central tube 301 with one end connected to the central cavity 201a, and a mounting portion at the other end of the central tube 301, on the surface of which the mating profile 301a is formed. To prevent the alignment conditions from being too harsh. The mounting portion is provided with a screw hole 301b through which the other end of the center pipe 301 is fixed in the filter assembly 300 by a screw.

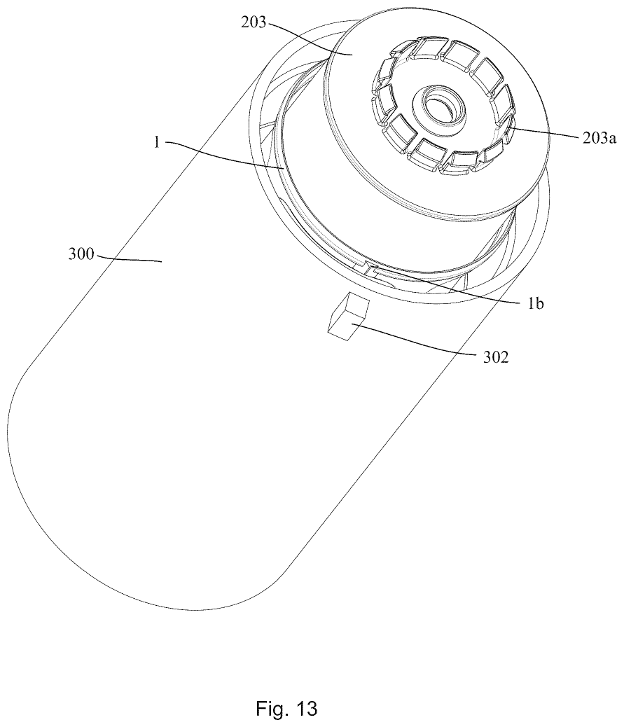

As a preferred embodiment, in order to realize the correct installation of the connecting piece 100 or the filter element assembly, please refer to FIG. 13. When the oil return plug 21 completely enters and closes the oil return channel 300a in the filter assembly 300, the other end of the hollowed-out bracket 1 is flush with the open end of the filter assembly 300 to remind the operator that the connecting piece 100 or the filter element assembly has been installed. O that the screw cap 400 can be screwed into full threaded engagement with the filter assembly 300. Alternatively, the end of the hollowed-out bracket 1 is further provided with a first identification part 1b, and the outer wall of the filter assembly 300 is further provided with a second identification part 302. When the oil return plug 21 completely enters and closes the oil return channel 300a in the filter assembly 300, the first identification part 1b is flush with the second identification part 302, which can also prompt the operator. The connecting piece 100 or filter assembly 300 has been completely installed. In addition, when the screw cap 400 is installed, the top surface of the inner periphery of the screw cap 400 is provided with a matching part 400a, and the second end cap 203 of the filter element 200 is provided with a clamping part 203a, so that the screw cap 400 and the filter element 200 can be clamped with each other. In this embodiment, the matching part 400a is an annular bayonet, and the clamping part 203a is a buckle arranged in a circumferential direction, so that the fitting portion 400a and the clamping part 203a can rotate relative to each other after the screw cap 400 is connected to the filter element 200. Therefore, the operator can choose to install the filter element 200 in the following ways without much experience.

The filter element 200 and the connecting piece 100 are connected and installed in the filter assembly 300 as an assembly. After the oil return plug 21 accurately enters and seals the oil return channel 300a, and the end of the hollowed-out bracket 1 is flush with the opening end of the filter assembly 300, the screw cap 400 is pressed down and connected with the filter element 200. Finally, the screw cap 400 is rotated and the complete threaded connection with the filter assembly 300 is achieved.

The second installation method is to independently install the connecting piece 100 in the filter assembly 300, and after the oil return plug 21 accurately enters and seals the oil return channel 300a, and the end of the hollowed-out bracket 1 is flush with the opening end of the filter assembly 300, connect the screw cap 400 with the filter element 200. The first end cap 202 of the filter element 200 is then pressed down together and connected to the connecting piece 100, and finally the screw cap 400 is rotated and fully threaded to the filter assembly 300.

The third installation method is to install the connecting piece 100, the filter element 200 and the screw cap 400 to the filter assembly 300 in turn.

The fourth installation method is to connect the connecting piece 100, the filter element 200 and the screw cap 400 together in turn, and then install them to the filter assembly 300.

On the other hand, when the filter element 200 is disassembled, after the rotary cap 400 is rotationally unscrewed, the screw cap 400 takes out the filter element 200, and at the same time, the filter element 200 takes out the connecting piece 100, that is, the disassembly is completed.

When the oil return channel 300a in the filter assembly 300 is not closed by the oil return plug 21, the screw cap 400 and the filter assembly 300 cannot be screwed together. That is, when the oil return plug 21 does not enter the oil return channel 300a, the male screw of the screw cap 400 and the female screw of the filter assembly 300 cannot be coupled to prevent incorrect installation. It should be understood that the length of the oil return plug 21 should correspond to the length of the thread of the screw cap 400. When the connecting piece 100 is installed abnormally, the hollowed-out bracket 1 will be obviously higher than opening end face of the filter assembly 300, which will be found by the operator, thus further playing a role in preventing misassembly.

The technical features of the above embodiments may be combined arbitrarily, and all possible combinations of the technical features in the above embodiments are not described for the sake of brevity. However, as long as there is no contradiction between the combinations of these technical features, they should be considered to be within the scope of this specification.

The above embodiments only represent several embodiments of the present application, and the description is more specific and detailed, but it should not be understood as a limitation to the scope of the invention. It should be noted that, for those of ordinary skill in the art, a number of modifications and improvements may be made without departing from the concept of the present application, which fall within the scope of the present application. Therefore, the scope of protection of the present patent application shall be subject to the appended claims.

What is claimed is:

1. A connecting piece comprising:
the hollowed-out bracket which is arranged on a periphery of a filter element in a surrounding manner and is used for radially limiting the filter element;
an end disc connected with one end of the hollowed-out bracket, wherein an oil return plug is eccentrically arranged on the outer end surface of the end disc and is used for sealing an oil return channel in the filter assembly; and wherein
the hollowed-out bracket is provided with a connecting part for connecting the filter element, so that the connecting part is moved out together with the filter element in the process of moving out the filter element, the oil return plug is removed, and the oil return channel is opened.

2. The connecting piece according to claim 1, wherein the end disc is hollow.

3. The connecting piece according to claim 1, wherein the end disc has an outwardly extending locating profile for mating with an internal component of the filter assembly, so that when the connecting piece is mounted in the filter assembly, the oil return plug enters and closes the oil return channel.

4. The connecting piece according to claim 3, wherein the locating profile is a wall extending axially outwards from the end face of the end disc.

5. The connecting piece according to claim 4, wherein the wall includes at least one bend to position the connector within the filter assembly.

6. The connecting piece according to claim 1, wherein the hollowed-out bracket and the end disc are integrally injection-moulded.

7. The connecting piece according to claim 3, wherein the hollowed-out bracket and the end disc are integrally injection-moulded.

8. The connecting piece according to claim 1, wherein the connecting part is provided in a plurality of elastic structure.

9. The connecting piece according to claim 8, wherein the elastic structure is a cantilever structure for detachably connecting the filter element.

10. The connecting piece according to claim 3, wherein the connecting part is provided in a plurality of elastic structure.

11. The connecting piece according to claim 10, wherein the elastic structure is a cantilever structure for detachably connecting the filter element.

12. A filter element assembly comprising a filter element and a connecting piece according to claim 1, wherein the filter element comprises:
an annular filter medium having a central cavity set around its central axis, and a first end cap and a second end cap connected to both ends of the annular filter medium;
wherein the hollowed-out bracket is arranged around the periphery of the annular filter medium and is connected with one of the first end cap and the second end cap.

13. The filter element assembly according to claim 12, wherein the first end cap is arranged close to the end disc, and the first end cap and the end disc are respectively provided with a first opening and a second opening into the central cavity.

14. A filter comprising:
the filter element assembly of claim 12;
a filter assembly, the filter assembly being provided with an oil return channel, the filter assembly being provided with a central tube communicating with the central cavity;
a screw cap and connect it with the open end thread of the filter assembly to seal it.
